(19) United States
(12) Patent Application Publication
(10) Pub. No.: US 2006/0251456 A1
(43) Pub. Date: Nov. 9, 2006

(54) Image forming apparatus

(76) Inventors: Kyung-pyo Kang, Suwon-si (KR); Hyoung-il Kim, Suwon-si (KR)

Correspondence Address: STANZIONE & KIM, LLP, 919 18TH STREET, N.W., SUITE 440, WASHINGTON, DC, 20006, US

(21) Appl. No.: 11/357,136

(22) Filed: Feb. 21, 2006

(30) Foreign Application Priority Data
May 3, 2005 (KR) 2005-36957

(51) Int. Cl. B41J 29/38; B41J 11/00

(52) U.S. Cl. 400/76; 400/578

(57) ABSTRACT

An image forming apparatus constantly forms images of the same length at each of printing periods by conveying a printing medium at a constant speed. The image forming apparatus includes a driving motor to provide a driving force, a conveying unit to convey a printing medium by receiving the driving force from the driving motor, and a printer head to form images according to printing data on each line of the printing medium at a predetermined printing period (Cp), wherein the printing period (Cp) is set as a positive integer multiplied by a cogging torque cycle of the driving motor.

### CROSS-REFERENCE TO RELATED APPLICATIONS

This application claims the benefit of Korean Patent Application No. 2005-36957, filed May 3, 2005, in the Korean Intellectual Property Office, the disclosure of which is incorporated herein by reference in its entirety.

### BACKGROUND OF THE INVENTION

1. Field of the Invention

The present general inventive concept relates to an image forming apparatus, and more particularly, to an image forming apparatus that forms an image on a printing medium while the printing medium is constantly conveyed at a predetermined speed.

2. Description of the Related Art

An image forming apparatus forms images on a printing medium that is conveyed. The image forming apparatus may be a printer, a scanner, or a facsimile. Some types of image forming apparatuses include a print head that has a width equal to that of the printing medium. These image forming apparatuses constantly convey the printing medium at a predetermined speed while the print head forms images on the printing medium. These image forming apparatuses can be classified as an array type inkjet printer or a thermal type printer. The array type inkjet printer includes an array type print head including a plurality of ink nozzles. The ink nozzles are disposed at the print head to extend along the width of the printing medium. The thermal type printer includes a thermal print head (TPH) having heaters which are arranged to extend along the width of the printing medium, instead of the ink nozzles. The thermal type printer applies heat to the printing medium, i.e., a heat sensitive printing paper, to form an image.

These image forming apparatuses form images in a line of the printing medium during a printing period (one line per print period). The printing period is a time of printing images on each line of the printing medium. Accordingly, a length of the images formed on each line may change in a conveying direction of the printing medium according to a conveying speed of the printing medium because of the printing period. Therefore, the printing medium must be constantly conveyed at a predetermined conveying speed during the printing period.

FIG. 1 is a graph illustrating a relationship between a cogging torque variation (represented by the curve line) of a driving motor and a length of an image formed on each line of a printing medium in a conventional image forming apparatus. The printing medium is conveyed by a convey roller which is driven by the driving motor. However, the driving motor regularly generates the cogging torque at a predetermined interval. The cogging torque is a variation of the driving motor's torque (Tq) and it is generated by cogging. Because of the cogging torque variation, a driving speed of the driving motor also changes at the same interval as the cogging torque. As a result, the conveying speed of the printing medium periodically varies according to the driving motor.

This variation of the conveying speed changes a convey distance per printing period (Cp). Therefore, lengths of the images D1, D2, D3 formed during the printing periods (Cp) become varied. That is, the lengths of images D1, D2, D3 in the conveying direction vary. For example, the length of the line image D1 is shorter, since the cogging torque (Tq) of the driving motor is at a local minimum during the corresponding printing period (Cp) such that the convey roller is rotated by an amount that is below an average that is represented by a horizontal solid line. This variation in lengths of lines of the image degrades image quality of the conventional image forming apparatus.

### SUMMARY OF THE INVENTION

Accordingly, the present general inventive concept provides an image forming apparatus to form images to have a constant length for every printing period without regard to a cogging torque variation of a driving motor that provides a driving force to convey a printing medium.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming apparatus including a driving motor to provide a driving force, a conveying unit to convey a printing medium by receiving the driving force from the driving motor, and a printer head to form images according to printing data on each line of the printing medium at a predetermined printing period (Cp), wherein the printing period (Cp) is set as a positive integer multiplied by a cogging torque cycle of the driving motor.

The conveying unit may include a conveying roller being rotated by receiving the driving force from the driving motor, and a sensor unit to sense a rotation speed of the conveying roller. The sensor unit may include a code wheel having a plurality of slots within a predetermined space of a circumference direction and being rotated with the conveying roller about an axis that is the same as an axis of the conveying roller, and an encoder sensor to sense the slots of the code wheel and to generate pulse signals in response to the sensed slots. A number L_{E} of the pulse signals corresponding to the printing period (Cp) may be calculated by:

$${L}_{E} = {P}_{N} \frac{{RN}_{S}}{{N}_{C}}$$

where P_{N}=a positive integer, Ns represents a number of slots formed on the code wheel, Nc represents a number of cogging torque cycles per one rotation of the driving motor, and R represents a gear ratio between the driving motor and the conveying roller.

The image forming apparatus may further include a driving force transferring unit to transfer the driving force of the driving motor to the conveying roller. The driving force transferring unit may include a motor gear arranged on a same axis as an axis of the driving motor and being rotated with the driving motor, and a feed gear geared with the motor gear and being rotated about a same axis as an axis of the conveying roller. The gear ratio R between the driving motor and the conveying roller may represent a gear ratio between the motor gear and the feed gear.

The foregoing and/or other aspects of the present general inventive concept are also achieved by providing a driving apparatus usable with an image forming device, the apparatus comprising a driving motor having a substantially periodic torque variation and to produce a driving force by rotation, a conveying roller to receive the driving force from the driving motor and to rotate to convey a print medium a predetermined conveying distance during a printing period, and a printing unit to print a line of printing data on the print medium each printing period such that the print period corresponds to the periodic torque variation of the driving roller.

The foregoing and/or other aspects of the present general inventive concept are also achieved by providing a driving apparatus usable with an image forming device, the apparatus comprising a conveying unit to convey a print medium in the image forming device each time a line of an image is to be printed, and a motor to generate torque having periodic variations and to drive the conveying unit over a driving period each time the line of the image is to be printed such that each driving period includes one or more full variations of the torque generated by the motor.

The foregoing and/or other aspects of the present general inventive concept are also achieved by providing a driving apparatus usable with an image forming device, the apparatus comprising a driving motor to produce a driving force having a torque variation and having a first gear, a conveying roller having a second gear to receive the driving force from the first gear of the driving motor and to convey a print medium by rotation, and a printing unit to print a plurality of lines of printing data on the print medium during a plurality of corresponding print periods. A gear ratio between the first gear and the second gear is set such that an average torque variation for each of the print periods is constant.

The foregoing and/or other aspects of the present general inventive concept are also achieved by providing an image forming apparatus, comprising a conveying unit to convey a printing medium at a constant speed line amount by line amount including a conveying roller to contact the printing medium and a feed gear to receive power and rotate the conveying roller, a print head to print printing data line by line on the printing medium while the printing medium is conveyed by the conveying unit, and a driving apparatus including a motor to rotate and provide a driving force to the conveying unit and having a predetermined number of slots where a metal coil is wound and a predetermined number of magnets such that each rotation of the motor has a predetermined number of full cogging torque cycles that corresponds to a product of the predetermined number of slots and the predetermined number of magnets and a driving gear to rotate with the motor such that the driving gear applies the power to the feed gear. The driving gear has a predetermined gear ratio with the feed gear such that one or more full cogging torque cycles occur while the conveying roller is rotated by an amount to convey the printing medium by a single line amount.

### BRIEF DESCRIPTION OF THE DRAWINGS

The above aspects of the present general inventive concept will be more apparent by describing certain embodiments of the present general inventive concept with reference to the accompanying drawings, in which:

FIG. 1 is a graph illustrating a relationship between cogging torque variation of a driving motor and a length of an image formed on each line of a printing medium in a conventional image forming apparatus;

FIG. 2 is a schematic diagram illustrating an image forming apparatus according to an embodiment of the present general inventive concept;

FIG. 3 is a block diagram illustrating the image forming apparatus of FIG. 2; and

FIG. 4 is a graph illustrating a relationship between cogging torque variation of a driving motor in the image forming apparatus of FIG. 2, a pulse signal of an encoder sensor, and a length of an image formed on each line of a printing medium according to an embodiment of the present general inventive concept.

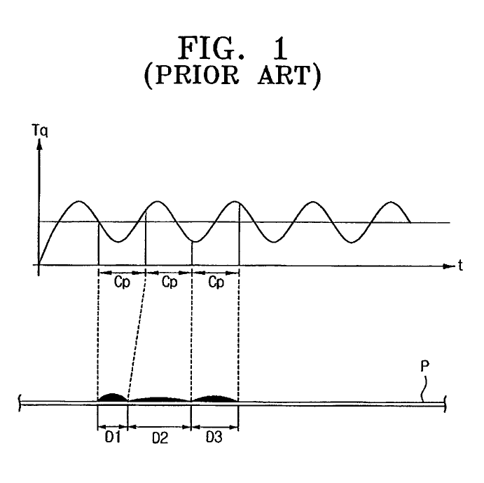

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

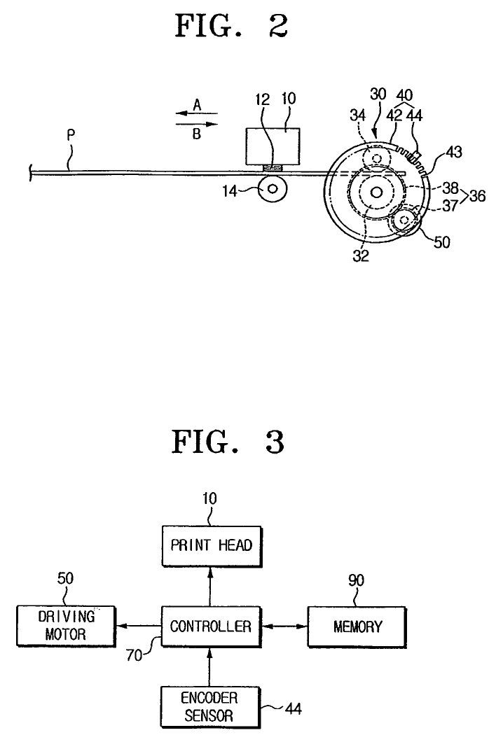

FIG. 2 is a schematic diagram illustrating an image forming apparatus according to an embodiment of the present general inventive concept, and FIG. 3 is a block diagram illustrating the image forming apparatus of FIG. 2.

Referring to FIGS. 2 and 3, the image forming apparatus according to the present embodiment includes a printer head 10 to form images on a printing medium P according to printing data, a conveying unit 30 to convey the printing medium P, a driving motor 50 to drive the conveying unit 30, a controller 70 to control the driving motor 50 and the printer head 10, and a memory 90 to store control programs of the controller 70.

A width of the printer head 10 may be about equal to a width of the printing medium P. Alternatively, the width of the printer head 10 may be slightly greater than the width of the printing medium P. A plurality of heaters 12 are arranged on a surface of the printer head 10 to face the printing medium P in a direction that is perpendicular to a conveying direction of the printing medium P. A heat sensitive paper may be used as the printing medium P. The heat sensitive paper forms different color images according to a temperature of heat applied by the heaters 12. A supporting roller 14 is disposed under the printer head 10 to support the printing medium P That is, the printing medium P conveyed below the printer head 10 is closely adhered to the printer head 10 by the supporting roller 14.

The conveying unit 30 includes a conveying roller 32 to convey the printing medium P, a power transferring unit 36 to transfer a driving force of the driving motor 50 to the conveying roller 32, and a sensor unit 40 to sense information about a position and a conveying speed of the printing medium P.

The conveying roller 32 receives the driving force from the driving motor 50 and is rotated accordingly while contacting an idle roller 34. As illustrated in FIG. 2, the image forming apparatus according to the present embodiment may include only one idle roller 34. However, the number of the idle rollers may be varied (i.e., more than one) according to a design of a printing medium convey passage.

The driving force transferring unit 36 includes a motor gear 37 arranged on a same axis as the driving motor 50, and a feed gear 38 being geared with the motor gear 37 and arranged at a same axis as the conveying roller 32. Accordingly, the motor gear 37 is rotated with the driving motor 50 at a same rotating speed (i.e., a first rotating speed) when the driving motor 50 is rotated. When the motor gear 37 is rotated, the feed gear 38 is rotated at a rotating speed related to a predetermined gear ratio R with the motor gear 37 (i.e., a second rotating speed). That is, a ratio of a rotating speed between the conveying roller 32 and the driving motor 50 is equal to the predetermined gear ratio R between the motor gear 37 and the feed gear 38, which is calculated by Eq. 1. That is, the first rotating speed of the driving motor 50 can be related to the second rotating speed of the conveying roller 32 by the predetermined gear ratio R.

$$R = \frac{{G}_{m}}{{G}_{f}} \qquad Eq . 1$$

In Eq. 1, Gₘ represents a number of teeth of the motor gear 37, and G_{f} represents a number of teeth of the feed gear 38.

The sensor unit 40 includes a code wheel 42 and an encoder sensor 44.

The code wheel 42 is arranged on the same axis of the conveying roller 32 and is rotated at the same speed as the conveying roller 32 (i.e., the second rotating speed). Additionally, the code wheel 42 includes a plurality slots 43 formed along a circumference direction.

The encoder sensor 44 senses the slots 43 of the code wheel 42 and generates pulse signals corresponding to a number of the slots 43 that are sensed. The encoder sensor 44 is connected to the controller 70 to exchange signals therewith. That is, the encoder sensor 44 transfers the pulse signals to the controller 70.

The driving motor 50 provides the driving force to rotate the conveying roller 32. While driving the conveying roller 32, the driving motor 50 generates a ripple of cogging torque generated at a predetermined cycle. The ripple of cogging torque is generated when torque applied to a rotator of the driving motor 50 is varied by electric field generated from a coil and one or more permanent magnets of the driving motor 50. A number of cogging torque cycles (Nc) per one rotation of the driving motor 50 is calculated by multiplying the number of slots where the coil is wound with a number of the permanent magnets in the driving motor 50.

The controller 70 receives printing data from a host (not shown) or a memory device and processes the received printing data. The controller 70 transmits the processed printing data to the printer head 10. The controller 70 calculates a printing time by counting the pulse signals generated by the encoder sensor 40 and a printing period (Cp) which is a time used to form an image on each line of the printing medium P. The controller 70 controls the printer head 10 according to the printing time and the printing period (Cp) to form images on each line of the printing medium P which is conveyed at a predetermined constant conveying speed.

The memory 90 is a storing medium to store control programs used to generally control the driving of the image forming apparatus. In particular, the pulse signals generated by the encoder sensor 44, the printing period (Cp), and the number of cogging torque cycles (Nc) are stored in the memory 90.

Hereinafter, an operation of the image forming apparatus according to the present embodiment will be explained with reference to FIGS. 2 through 4.

The image forming apparatus receives a printing request and the printing data from the host (not shown) such as a computer or the memory device. The controller 70 drives a pickup unit (not shown) to pickup the printing medium P and simultaneously drives the driving motor 50. The driving force of the driving motor 50 is transferred to the conveying roller 32 through the motor gear 37 and the feed gear 38. The conveying roller 32 conveys the picked-up printing medium P in a direction A. Herein, the printer head 10 does not yet perform a printing operation. After the printing medium P is conveyed farther than a predetermined distance in the direction A, the controller 70 inverse-rotates the driving motor 50 to convey the printing medium P in a direction B. After conveying the printing medium P in the direction B, the controller transmits the printing data to the printer head 10 to perform the printing operation.

Hereinafter, setting of the printing time and the printing period (Cp) of the printer head 10 will be described in detail with reference to FIGS. 2 to 4.

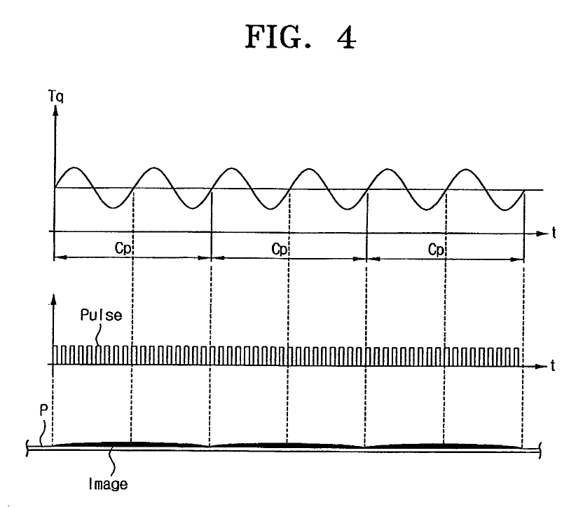

FIG. 4 is a graph illustrating a relationship between cogging torque (Tq) variation of the driving motor 50 of the image forming apparatus of FIG. 2, the pulse signals of the encoder sensor 44, and a length of an image formed on each line of the printing medium P

As described above, the cogging torque (Tq) of the driving motor 50 is varied Nc times per one rotation of the driving motor 50. Nc represents the cogging torque cycles described above. For example, the cogging torque (Tq) is changed 6 times per one rotation as illustrated in FIG. 4. In other words, the cogging torque cycle (Nc) corresponds to the time that it takes the cogging torque (Tq) to change with respect to an average cogging torque value. That is, the cogging torque cycle (Nc) corresponds to an amount of time between each time the cogging torque (Tq) reaches a maximum value or an amount of time between each time the cogging torque (Tq) reaches a minimum value. Thus, as illustrated in FIG. 4, there are two cogging torque cycles per the printing period (Cp). The cogging torque variation of the driving motor 50 changes a speed of the driving motor 50 (i.e., the first rotating speed), and the changed speed of the driving motor 50 also changes a speed of the conveying roller 32 (i.e., the second rotating speed). This change in speed of the conveying roller 32 in turn varies a conveying distance of the printing medium (P) per the printing period (Cp) which is the time used to print images of one line of the printing medium P. Since the speed of the driving motor 50 is an integrating value of the cogging torque (Tq) of the driving motor 50 with respect to time, if each of the printing periods (Cp) is a positive integer multiplied by the cogging torque cycle (Nc), the speed of the driving motor 50 per printing period (Cp) is constant. That is, if the speed of the driving motor 50 is constant at each of the printing periods (Cp), the speed of the conveying roller 32 per each printing period (Cp) is also constant. Accordingly, the conveying distance per each printing cycle (Cp) remains constant for each printing cycle (Cp).

In the present embodiment, the printing period (Cp) may be set as a value that is proportional to the pulse signals generated by the encoder sensor 43 and stored in the memory 90. That is, the printing period (Cp) may be set as a time it takes to count a predetermined number of the pulse signals L_{E}. Therefore, the number of pulse signals L_{E} per the printing period (Cp), which makes the printing period (Cp) equal to the integer multiplied by the cogging torque cycle (Nc), can be calculated by Eq. 2.

$${L}_{E} = {P}_{N} \frac{{RN}_{S}}{{N}_{C}} \qquad Eq . 2$$

In Eq. 2, N_{S} represents the number of slots 43 formed on the code wheel 42. That is, N_{S} represents the number of pulse signals sensed by the encoder sensor 44 while the code wheel 42 rotates one time. Nc represents the number of cogging torque cycles (Nc) per one rotation of the driving motor 50. R is the predetermined gear ratio calculated by Eq. 1 (above), or represents a rotation speed ratio between the convey roller 32 and the driving motor 50 (i.e., the ratio of the first rotating speed to the second rotating speed described above). Therefore, RNs/Nc represents the number of pulse signals per one cogging torque cycle (Nc). As a result, the number of pulse signals L_{E} per printing period (Cp) becomes a positive integer P_{N} multiplied by the number of pulse signals per one cogging torque cycle (RNs/Nc). Accordingly, the printing period (Cp) also becomes the positive integer P_{N} multiplied by the cogging torque cycle (Nc). In the present embodiment of FIG. 4, the number of cogging torque cycles Nc per one rotation of the driving motor 50 is set as 6, RNs (which represents the predetermined gear ratio R times the number of slots Ns on the code wheel 42) is set as 9, and P_{N} (which represents the positive integer multiple) is set as 12. Accordingly, L_{E} (the number of pulse signals per printing period (Cp)) becomes 18. Therefore, one printing period (Cp) corresponds to 18 pulse signals, and the number of the cogging torque cycles (Nc) is 2 per the printing period (Cp). In other words, the predetermined gear ratio R is selected such that an average cogging torque (Tq) is constant over the printing periods (Cp). For example, the cogging torque cycle (Nc) of the driving motor 50 may be calculated, and the gear ratio R between the motor gear 37 and the feed gear 38 can be selected such that the conveying roller 32 moves the printing medium (P) a conveying distance during the printing period (Cp), which include one or more full cogging torque cycles (Nc). Since each printing period (Cp) includes the one or more full cogging torque cycles (Nc) an amount of torque applied to the conveying roller 32 during each printing period (Cp) remains a constant such that the conveying distance for each printing period (Cp) also remains a constant.

In the present embodiment, a thermal type printer having a thermal printer head (TPH) is illustrated as an embodiment of the present general inventive concept. However, the present general inventive concept may be applied to any image forming apparatus that forms images on a printing medium which is conveyed at a constant speed. For example, the present general inventive concept may be applied to an inkjet printer including an array type printer head including a plurality of nozzles arranged along a width of a printing medium to eject ink on the printing medium.

As described above, in the embodiments of the present general inventive concept, a printing period is set as a positive integer multiplied by a cogging torque cycle of a driving motor. Therefore, an image forming apparatus according to these embodiments can constantly convey a printing medium at a predetermined speed for each of the printing periods without regard to a variation in the cogging torque cycle of the driving motor. Accordingly, the image forming apparatus according to the embodiments of the present general inventive concept provides an improved image quality because same lengths of images are constantly formed on the printing medium at each of printing periods.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a driving motor to provide a driving force;
a conveying unit to convey a printing medium by receiving the driving force from the driving motor; and
a printer head to form images according to printing data on each line of the printing medium at a predetermined printing period (Cp),
wherein the printing period (Cp) is set as a positive integer multiplied by a cogging torque cycle of the driving motor.

2. The image forming apparatus of the claim 1, wherein the conveying unit comprises:
a conveying roller being rotated by the driving force received from the driving motor; and
a sensor unit to sense a rotation speed of the conveying roller.

3. The image forming apparatus of claim 2, wherein the sensor unit comprises:
a code wheel having a plurality of slots within a predetermined space of a circumference direction and being rotated with the conveying roller about an axis that is the same as an axis of the conveying roller; and
an encoder sensor to sense the slots of the code wheel and to generate pulse signals in response to the sensed slots.

4. The image forming apparatus of claim 3, wherein a number L_{E} of the pulse signals corresponding to the printing period (Cp) is calculated by:
$${L}_{E} = {P}_{N} \frac{{RN}_{S}}{{N}_{C}} ,$$
where P_{N}=a positive integer, N_{S} represents a number of slots formed on the code wheel, Nc represents a number of cogging torque cycles per one rotation of the driving motor, and R represents a gear ratio between the driving motor and the conveying roller.

5. The image forming apparatus of claim 4, further comprising:
a driving force transferring unit to transfer the driving force of the driving motor to the conveying roller, the driving force transferring unit comprising
a motor gear arranged on a same axis as an axis of the driving motor and being rotated with the driving motor, and
a feed gear geared with the motor gear and being rotated about a same axis as an axis of the conveying roller.

6. The image forming apparatus of claim 5, wherein the gear ratio R between the driving motor and the conveying roller represents a gear ratio between the motor gear and the feed gear.

7. The image forming apparatus of claim 1, wherein the printing period corresponds to an amount of time during which the conveying unit conveys the printing medium by a conveying distance to print one of the line images thereon.

8. The image forming apparatus of claim 7, wherein an average of a cogging torque of the driving motor is the same for each printing period such that the conveying distance for each printing period is the same.

9. The image forming apparatus of claim 1, wherein the printer head comprises one of a thermal print head and an inkjet head.

10. An image forming apparatus to form an image at a predetermined printing period (Cp) on a printing medium while the printing medium is being conveyed at a constant speed, wherein the printing period is set as a predetermined positive integer multiplied by a cogging torque cycle of a driving motor.

11. A driving apparatus usable with an image forming device, the apparatus comprising:
a driving motor having a substantially periodic torque variation and to produce a driving force by rotation;
a conveying roller to receive the driving force from the driving motor and to rotate to convey a print medium a predetermined conveying distance during a printing period; and
a printing unit to print a line of printing data on the print medium each printing period such that the print period corresponds to the periodic torque variation of the driving roller.

12. The driving apparatus of claim 11, wherein:
the periodic torque variation comprises a cogging torque cycle; and
the printing period comprises an amount of time that contains more than one cogging torque cycle.

13. The driving apparatus of claim 11, wherein:
the driving motor comprises a driving gear; and
the conveying roller comprises a feed gear that engages the driving gear with a predetermined gear ratio such that a predetermined number of full torque variations of the driving motor occur within the printing period during which the conveying roller conveys the printing medium the predetermined conveying distance.

14. The driving apparatus of claim 13, wherein the driving gear has a smaller circumference than the feed gear.

15. The driving apparatus of claim 13, further comprising:
a code wheel rotatable with the conveying roller about the same axis and having a plurality of indicators arranged about a circumference thereof; and
an encoder sensor to sense the indicators on the code wheel to detect information about rotation of the code wheel and to generate pulse signals according to the sensed indicators.

16. The driving apparatus of claim 15, wherein a number L_{E} of the pulse signals corresponding to the printing period is calculated by:
$${L}_{E} = {P}_{N} \frac{{RN}_{S}}{{N}_{C}} ,$$
where P_{N}=a positive integer, N_{S} represents a number of indicators formed on the code wheel, Nc represents a number of torque variations in each full rotation of the driving motor, and R represents the predetermined gear ratio between the driving gear and the feed gear.

17. A driving apparatus usable with an image forming device, the apparatus comprising:
a conveying unit to convey a print medium in the image forming device each time a line of an image is to be printed; and
a motor to generate torque having periodic variations and to drive the conveying unit over a driving period each time the line of the image is to be printed such that each driving period includes one or more full variations of the torque generated by the motor.

18. The driving apparatus of claim 17, wherein the conveying unit and the motor comprise first and second gears, respectively, having a relationship such that the motor drives the conveying unit to convey the print medium at a constant speed in each driving period.

19. A driving apparatus usable with an image forming device, the apparatus comprising:
a driving motor to produce a driving force having a torque variation and having a first gear;
a conveying roller having a second gear to receive the driving force from the first gear of the driving motor and to convey a print medium by rotation; and
a printing unit to print a plurality of lines of printing data on the print medium during a plurality of corresponding print periods, wherein a gear ratio between the first gear and the second gear is set such that an average torque variation for each of the print periods is constant.

20. The driving apparatus of claim 19, wherein each print period includes one or more torque variations having a time between either local maxima of a driving torque as a function of time and or a time between local minima of the driving torque as the function of time.

21. An image forming apparatus, comprising:
a conveying unit to convey a printing medium at a constant speed, line amount by line amount, including
a conveying roller to contact the printing medium, and
a feed gear to receive power and rotate the conveying roller;
a print head to print printing data line by line on the printing medium while the printing medium is conveyed by the conveying unit; and
a driving apparatus, including
a motor to rotate and provide a driving force to the conveying unit and having a predetermined number of slots where a metal coil is wound and a predetermined number of magnets such that each rotation of the motor has a predetermined number of full cogging torque cycles that corresponds to a product of the predetermined number of slots and the predetermined number of magnets, and
a driving gear to rotate with the motor such that the driving gear applies the power to the feed gear, wherein the driving gear has a predetermined gear ratio with the feed gear such that one or more full cogging torque cycles occur while the conveying roller is rotated by an amount to convey the printing medium by a single line amount.
